(19) United States
(12) Patent Application Publication
(10) Pub. No.: US 2014/0380458 A1
(43) Pub. Date: Dec. 25, 2014

(54) APPARATUS FOR PREVENTING ILLEGAL ACCESS OF INDUSTRIAL CONTROL SYSTEM AND METHOD THEREOF

(71) Applicant: ELECTRONICS AND TELECOMMUNICATIONS RESEARCH INSTITUTE, Daejeon (KR)

(72) Inventors: Byoung-Koo KIM, Daejeon (KR); Dong-Ho KANG, Daejeon (KR); Seon-Gyoung SOHN, Daejeon (KR); Young-Jun HEO, Daejeon (KR); Jung-Chan NA, Daejeon (KR)

(73) Assignee: ELECTRONICS AND TELECOMMUNICATIONS RESEARCH INSTITUTE, Daejeon (KR)

(21) Appl. No.: 14/245,310

(22) Filed: Apr. 4, 2014

(30) Foreign Application Priority Data
Jun. 20, 2013 (KR) 10-2013-0071138

(51) Int. Cl. H04L 29/06

(52) U.S. Cl. CPC H04L 63/0227
USPC 726/13

(57) ABSTRACT

Disclosed is an apparatus for preventing illegal access of industrial control system and a method thereof in accordance with the present invention. The apparatus for preventing illegal access of industrial control system includes: a first interface communicating a packet by interoperating with a management network group that requests a control command; a second interface communicating a packet by interoperating with a control network group that receives a control command from the management network group and processes it; and a control device, which, when a packet flows therein from the management network group or the control network group, checks whether or not at least one filter rule is set and controls the packet flow between the management network group and the control network group using the filter where the rule is set.

### CROSS-REFERENCE TO RELATED APPLICATIONS

This application claims the benefit of Korean Patent Application No. 10-2013-0071138, filed with the Korean Intellectual Property Office on Jun. 20, 2013, the disclosure of which is incorporated herein by reference in its entirety.

### BACKGROUND

1. Technical Field

The present invention relates to a method of preventing illegal access of industrial control system, more specifically to an apparatus for preventing illegal access of industrial control system and a method thereof which has an apparatus for preventing illegal access in order to control traffic flow between networks according to different rules by employing plurality of filters therein.

2. Background Art

An Industrial Control System (ICS) is a computer based system which is required for effective remote monitoring and controlling of distributed systems, and is widely used in major production and infrastructure facilities by doing industrial facilities measuring/control, plant facilities monitoring/management, power production/distribution, gas production/logistics, water resource management, traffic infrastructure control, and monitoring and control of various resource resources such as dam and oil. As Stuxnet, which is an example of a newly formed cyber tenor targeting major industrial control facilities appears in 2010, a threat of cyber warfare has been escalating seriously. Since an industrial control system controls a subject system directly in order to make the system operate normally, it requires high credibility and nationwide confusion will be followed if it is attacked.

An conventional control system had been implemented and operated independently in a closed network, however recently it has been connected and integrated to an external system through an open network such as Internet and has been switched to a standard and open system for the sake of work efficiency, competitiveness, and business rationalization.

In this wise, as a control system has been connected with Intranet and Internet and the connection between a control system and an IT system has been increasing consistently, the possibility of a cyber-attack on industrial control facilities where a control system is implemented and operated has increased.

Moreover, as control system's closed protocol has been open to global standard gradually, which resulted in providing attacker more knowledge about a control system and network, the possibility and risk of cyber-attack has been escalating.

Since a control system must not stop working even for a short time, and even when a problem is found on operating software of a control system, it is difficult to correct the problem immediately because enough verification on application stability of the correction is needed. Moreover a control system uses a system specific protocol creating a huge discrepancy from an IT system and thus a suitable study and development on security technique are required.

Since a security system such as a firewall, an intrusion detection/prevention system and the like does not apply the characteristics of a control system's independent protocol such as Modbus, ICCP, DNP3P and the like, it results in limitations on traffic detection/prevention for specialized attacks, thus it is required to develop and apply a technique for abnormal symptom detection and control specifically oriented to a control system.

Whereas an existing firewall performs access control for an unspecific plurality of systems and services, a control system performs access control for specific systems and services thereby requiring an illegal access control through more diverse and flexible access control techniques.

In conclusion, a concern has been increasing about activities which interrupt a control system to operate safely, however existing enterprise security system such a firewall, an intrusion detection/prevention system and the like are congregated in the network boundary area, having been vulnerable to problems of internal infrastructure. That is while intrusion pathways including internal threats are diverse and a control network also is focused on a boundary network security, less analytical measures for internal activities have been taken. Therefore in order to provide a credible service, a diverse technique for preventing illegal access specified to the control system's protocol is required.

### SUMMARY

The present invention is intended to resolve a conventional technical problem, and provides an apparatus for preventing illegal access of industrial control system and a method thereof which has an apparatus for preventing illegal access which controls traffic flow in accordance with the different rules of employed plurality of filters therein.

However, the goals of the present invention shall by no means restrict the present descriptions and the other goals not described shall be clearly understood by the following descriptions.

An apparatus for preventing illegal access of industrial control system in accordance with an aspect of the present invention to achieve the goals includes: a first interface communicating a packet by interoperating with a management network group that requests a control command; a second interface communicating a packet by interoperating with a control network group that receives a control command from the management network group and processes it; and a control device, which, when a packet flows therein from the management network group or the control network group, checks whether or not at least one filter rule is set and controls the packet flow between the management network group and the control network group using the filter where the rule is set.

In one embodiment, the control device can include a default filter which passes or blocks the packet in accordance with a preset value, and, if no filter rule is set, the control device passes or blocks the packet using the default filter.

In one embodiment, the control device can include a SCADA I/F filter which performs access control of the packet from the management network group, based on a rule having a source's address, and if a SCADA I/F filter rule is set, the control device passes or blocks the packet based on SCADA I/F filter rule.

In one embodiment, the control device can include a flow filter which performs access control of the packet from the management network group or the control network group, based on a rule having a protocol, a source's address, a destination address, a source's port, and a destination's port and, if no rule is set in the SCADA I/F filter or after the control device controls the packet through the SCADA I/F filter, the control device passes or blocks the packet according to whether or not the packet satisfies the flow filter rule.

In one embodiment, the control device can include a command filter which performs access control of the packet from the management network group or the control network group based on a rule which includes a command and, if no rule is set in the flow filter or after the packet is controlled through the flow filter, the control device passes or blocks the packet according to whether or not the packet satisfies the command filter rule.

In one embodiment, the control device can include a control I/F filter which performs access control of the packet from the control network group, based on a rule which includes a source's address, and the control device passes or blocks the packet according to whether or not the packet satisfies the control I/F filter rule set in the control I/F filter rule.

In one embodiment, the control device can include a flow filter which performs access control of the packet from the management network group or the control network group based on a rule which includes a protocol, a source's address, a destination address, a source's port, and a destination's port and if no rule exists in the control I/F filter or after the control device controls the packet through the control I/F filter, the control device passes or blocks the packet according to whether or not the packet satisfies the flow filter rule.

In one embodiment, the control device can include which performs access control of the packet from the management network group or the control network group, based on a rule which includes a command and if no rule exists in the flow filter or after the control device controls the packet through the flow filter, the control device passes or blocks the packet according to whether or not the packet satisfies the command filter rule.

A method for preventing illegal access of industrial control system in accordance with an aspect of the present invention includes: checking if a packet is received from a management network group which requests a control command or a control network group which receives and processes the control command; checking whether or not at least one filter rule exists if the packet is received either from the management network group or the control network group; and controlling a packet flow between the management network group and the control network group using a filter where the rule is set.

In one embodiment, the controlling can include checking a default filter which controls passing or blocking of a packet according to a preset value, if there is no other filter rule set; and controlling passing or blocking of the packet according to the preset value.

In one embodiment, the controlling can include checking a SCADA I/F filter which performs access control of a packet from the management network group based on a rule which includes a source's address, if the at least one filter rule is set; and controlling passing or blocking the packet according to whether or not the packet satisfies the SCADA I/F filter rule if the check result shows the SCADA I/F filter rule is set.

In one embodiment, the controlling can include, if no rule is set in the SCADA I/F filter or after the packet's passing or blocking is controlled by use of the SCADA I/F filter, checking a flow filter which performs access control of the packet from the management network group or the control network group based on a rule which includes a protocol, a source's address, a destination address, a source's port, and a destination's port; and controlling passing or blocking the packet according to whether or not the packet satisfies the flow filter rule if the check result shows the flow filter rule is set.

In one embodiment, the controlling can include, if no rule is set in the flow filter or after the packet's passing or blocking is controlled by use of the flow filter, checking a command filter which performs access control of the packet from the management network group or the control network group based on a rule which includes a command; and controlling passing or blocking the packet according to whether or not the packet satisfies the command filter rule, if the check result shows the command filter rule is set.

In one embodiment, the controlling can include checking a control I/F filter which performs access control of the packet from the control network group based on a rule which includes a source's address; and controlling passing or blocking the packet according to whether or not the packet satisfies the control filter rule if the control I/F filter rule is set.

In one embodiment, the controlling can include, if no rule is set in the control I/F filter or after the packet's passing or blocking is controlled by use of the control IF filter, checking a flow filter which performs access control of the incoming packets from the management network group or the control network group based on a rule which includes a protocol, a source's address, a destination address, a source's port, and a destination's port; and controlling passing or blocking the packet according to whether or not the packet satisfies the flow filter rule, if the check result shows the flow filter rule is set.

In one embodiment, the controlling can include, if no rule is set in the flow filter or after the packet's passing or blocking is controlled by use of the flow filter, checking a command filter which performs access control of the packet from the management network group or the control network group based on a rule which includes a command; and controlling passing or blocking the packet according to whether or not the packet satisfies the command filter rule, if the check result shows the command filter rule is set.

### BRIEF DESCRIPTION OF THE DRAWINGS

FIG. 1 schematically presents an industrial control system in accordance with an embodiment of the present invention.

FIG. 2 presents a detail structure of an apparatus for preventing illegal access in accordance with an embodiment of the present invention.

FIG. 3a to FIG. 3d present diagrams for explaining filter rules in accordance with an embodiment of the present invention.

FIG. 4a to FIG. 4b present cases for employing a default filter in accordance with an embodiment of the present invention.

FIG. 5 presents a first flowchart of a method for preventing illegal access in accordance with an embodiment of the present invention.

FIG. 6 presents a second flowchart of a method for preventing illegal access in accordance with an embodiment of the present invention.

FIG. 7 presents a flowchart of a process for default filter matching in accordance with an embodiment of the present invention.

FIG. 8 presents a flowchart of a process for SCADA I/F filter matching in accordance with an embodiment of the present invention.

FIG. 9 presents a flowchart of a process for control I/F filter matching in accordance with an embodiment of the present invention.

FIG. 10 presents a flowchart of a process for flow filter matching in accordance with an embodiment of the present invention.

FIG. 11 represents flowcharts explaining a process of applying a command filter rule in accordance with an embodiment of the present invention.

### DETAILED DESCRIPTION

Hereinafter, an apparatus for preventing illegal access of industrial control system and a method thereof accordance with an embodiment of the present invention will be illustrated and described with reference to the accompanying drawings of FIG. 1 to FIG. 11. It will be described in detail focusing on operations and actions in accordance with the present invention.

Also to describe the components of the present invention, different symbols for a same component can be used in different drawings and same symbols can be used in different drawings. However it does not mean a certain component acts differently in accordance with an embodiment nor the different components have a same function in different embodiments thus the functions of each component must be understood by the description about the component of the embodiment.

Particularly, the present invention has an apparatus for preventing illegal access to control traffic flow among networks and proposes a new method for preventing illegal access which controls traffic flow according to an individual rule by employing a plurality of filters which are in the device.

FIG. 1 schematically presents an industrial control system in accordance with an embodiment of the present invention.

As shown in FIG. 1, an industrial control system in accordance with one embodiment of the present invention may include a management network group 100, an apparatus for preventing illegal access 200, and a control network group 300. Here, Modbus TCP/IP protocol can be used among networks.

The management network group 100 indicates a control network where management systems area located such as a SCADA (Supervisory Control and Data Acquisition) system, a HMI (Human Machine Interface) system, and a Data Historian system. The management network group 100 can belong to a Modbus client group requesting a control command.

The control network group 300 indicates a control network consisting of systems which controls industrial facilities sensors such as PLC (Programmable Logic Controller) system, RTU (Remote Terminal Unit) system, DCS (Distributed control system). The control network group 300 can belong to Modbus server group which receives a control command and processes data.

The apparatus for preventing illegal access 200, is located between the management network group 100 and the control network group 300 and disposed on the line therebetween to be able to monitoring Modbus TCP/IP traffic, and communicates packets therebetween.

That is the apparatus for preventing illegal access 200 located between the management network group 100 and the control network group 300 controls traffic among the systems which request and manage control commands, and which apply the requested control commands to industrial facilities sensors and collect information.

The apparatus for preventing illegal access 200 can control traffic flow such as pass or block according to different rules by employing plurality of filters therein.

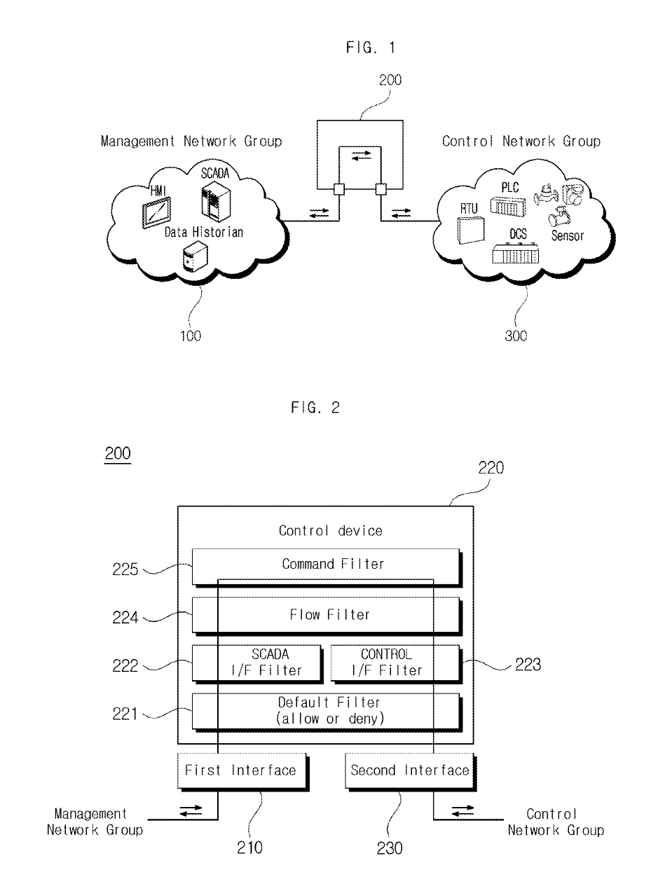

FIG. 2 presents a detail structure of the apparatus for preventing illegal access in accordance with an embodiment of the present invention.

As shown in FIG. 2, the apparatus for preventing illegal access 200 in accordance with the present invention may include a first interface 210, a control device 220, and a second interface 230. Here, the control device 220 may include a default filter 221, a SCADA I/F filter 222, a control filter 223, a flow filter 224, and a command filter 225.

The first interface 210 can interoperate with the management network group 100 to communicate a packet.

The second interface 230 can interoperate with the control network group 300 to communicate a packet.

When a packet is received from the management network group 100 or the control network group 300, the control device 220 checks all filter rules and uses a filter where the rule is set in accordance with the check result, thereby controlling the packet flow.

Here, the rule is not set on the default filter 221 but only on the SCADA I/F filter 22), the control filter 223, the flow filter 224, and the command filter 225.

For example, when there are all filters rules are set, then the control device 220 controls packet flow by use of the SCADA I/F filter 222 or the control filter 223, the flow filter 224, and the command filter 225.

Whereas, if any of filters rules are not set, then the control device 220 controls packet flow by use of only the default filter 221 which passes or blocks a packet.

The default filter 221 used only when the other filters are not used, can pass (allow) or block(deny) all packets coming from the management network group 100 or the control network group 300.

The SCADA I/F filter 222, which may be applied to all packets coming from the management network group 100 as an interface unit, can perform control access based on a source address.

The control filter 223, which may be applied to all packets coming from the control network group 300 as an interface unit, can perform control access based on a source address.

The flow filter 224 can perform access control based on a 5-tuple unit against the packets from the management network group 100 or the control network group 300. Here, the 5-tuple is a protocol, a source address, a destination address, and a destination port.

The command filter 225 can perform access control based on a Modbus command against the packets coming from the management network group 100 or the control network group 300.

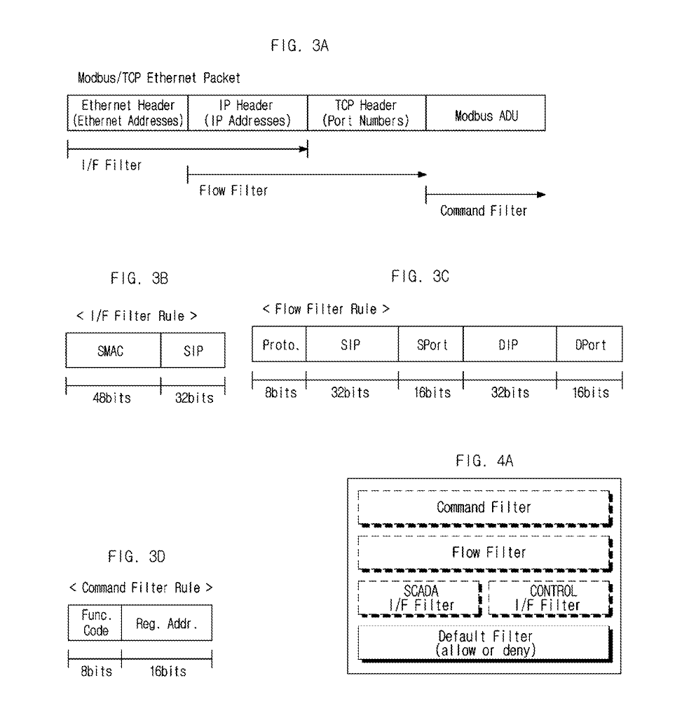

FIG. 3a to FIG. 3d present diagrams for explaining filter rules in accordance with an embodiment of the present invention.

Referring to FIG. 3a, the format of a Modbus/TCP Ethernet packet in accordance with the present invention can include a Ethernet Header(Ethernet Address), a IP Header(IP Address), a TCP Header(Port Number), and a Modbus ADU(Application Data Unit).

Referring to FIG. 3b, a filter rule for the I/F filters in accordance with the present invention, namely the SCADA I/F filter and the control I/F filter can include a source's MAC address, SMAC and a source's IP address, SIP.

Here, a SMAC can be set by 48 bits and a SIP by 32 bits.

For example, the SCADA I/F filter and the control I/F filter matches the value of the source's MAC address and the source's IP address within the filter rule, against the one of the source's MAC address and the source's IP address from the Ethernet header/IP header of the packet, and passes the packet if the matching is made.

These I/F filter rules in accordance with the present invention can be rules for transmitting a packet.

Referring to FIG. 3c, a flow filter rule in accordance with the present invention can include a protocol, proto., a source's IP address, SIP, a source's port, Sport, a destination's IP address, DIP, and a destination's port, DPort.

Here, the proto. can be set by 8 bits, the SIP by 32 bits, the Sport by 16 bits, the DIP by 32 bits, and the DPort by 16 bits.

For example, the flow filter matches the protocol, the source's IP address, the source's port, the destination's IP address, and a destination's port within the flow filter rule against the protocol, the source's IP address, the source's port, the destination's IP address and the destination's port of the IP header/TCP header of the packet, and sends or blocks the packet based on the matching result.

The flow filter rule in accordance with the present invention which can either pass or block a packet can be set and modified by an operator.

Referring to 3d, a command filter rule in accordance with the present invention can include a function code, Func. Code, a register address, Reg. Addr.

Here, the Func. Code can be set by 80. bits and the Reg. Addr. by 16 bits.

For example, the command filter matches the value of the function code and the register address of the command filter rule against the value of the function code and the register address from the Modbus ADU and passes or blocks the packet as a result of the matching.

The command filter rule in accordance with the present invention which can either pass or block a packet can be set and modified by an operator.

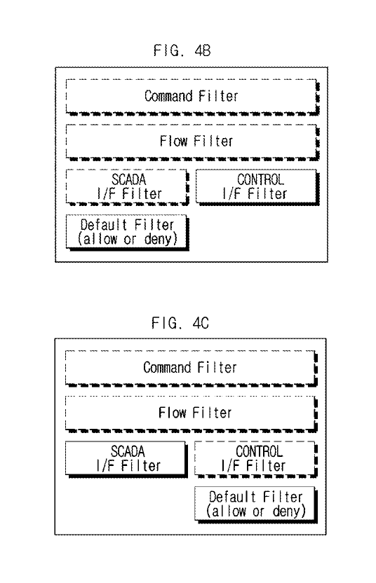

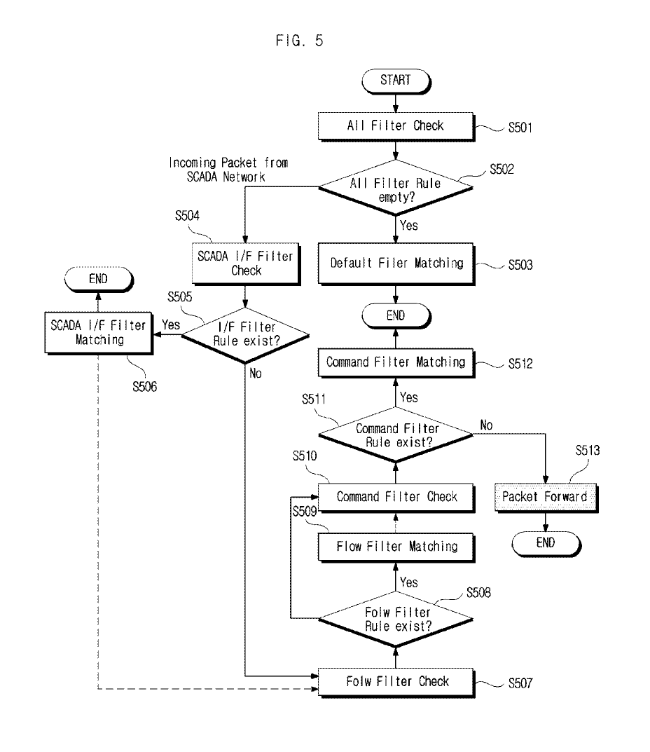

FIG. 4a to FIG. 4b present cases for employing a default filter in accordance with an embodiment of the present invention.

FIG. 4a shows a case where a default filter in the apparatus for preventing illegal access in accordance with the present invention is used. When there is no other filter rules, the default filter is used to pass or block a packet.

In other words, the SCADA I/F filter, the control I/F filter, the flow filter, or the command filter cannot control data flow if the corresponding rule is not set.

An operator can use the default filter in accordance with their intention in order to pass or block all the packets for an emergency.

FIG. 4b, shows a case where a control I/F filter rule in the apparatus for preventing illegal access in accordance with the present invention is used. In this case also the default filter is used and set to pass a packet.

Here, in accordance with the control I/F filter rule, the data packet can be passed or blocked.

FIG. 4c shows a case where a SCADA I/F FILTER rule in the apparatus for preventing illegal access in accordance with the present invention is used. In this case also the default filter is used and set to pass packet.

Here, in accordance with the SCADA I/F filter rule, the data packet can be passed or blocked.

FIG. 5 presents a first flowchart of a method for preventing illegal access in accordance with an embodiment of the present invention.

As shown in FIG. 5, it is assumed that a packet flows in from the management network group. An apparatus for preventing illegal access in accordance with the present invention can check all filters except a default filter when a packet flows therein from the management network group S501.

That is, the apparatus for preventing illegal access can judge whether or not all filters have rules therein with the check result S502.

Then, if the check result is there is no rule in all filters, the apparatus for preventing illegal access passes or blocks a packet in accordance with the default filter value set on the default filter S503.

Whereas, if the check result is at least one filter rule exists, the apparatus for preventing illegal access controls packet flow by using the corresponding filter as the packet flows in order therein.

At first, the apparatus for preventing illegal access checks the SCADA I/F filter S504 whether or not it has a filter rule S505. That is if there is a SCADA I/F filter rule exists, the apparatus for preventing illegal access can perform the SCADA I/F filter matching S506.

Whereas, in case that there does not exist SCADA I/F filter rule or after it performs the SCADA I/F filter matching, it then checks the flow filter at S507.

Next, the apparatus for preventing illegal access can judge whether or not a flow filter rule exists S508. That is, if a flow filter rule exists, then the apparatus for preventing illegal access can perform the flow filter matching S509.

Whereas, in case that no flow filter rule exists or after it performs the flow filter matching, it then checks command filter S510.

Next, the apparatus for preventing illegal access can judge whether or not a command filter rule exists S511. That is if a command filter rule exists, then the apparatus for preventing illegal access can perform the command filter matching S512.

Whereas, if there is no command filter rule exists, the apparatus for preventing illegal access can forward the packet judging at least one filter rule has been used S513.

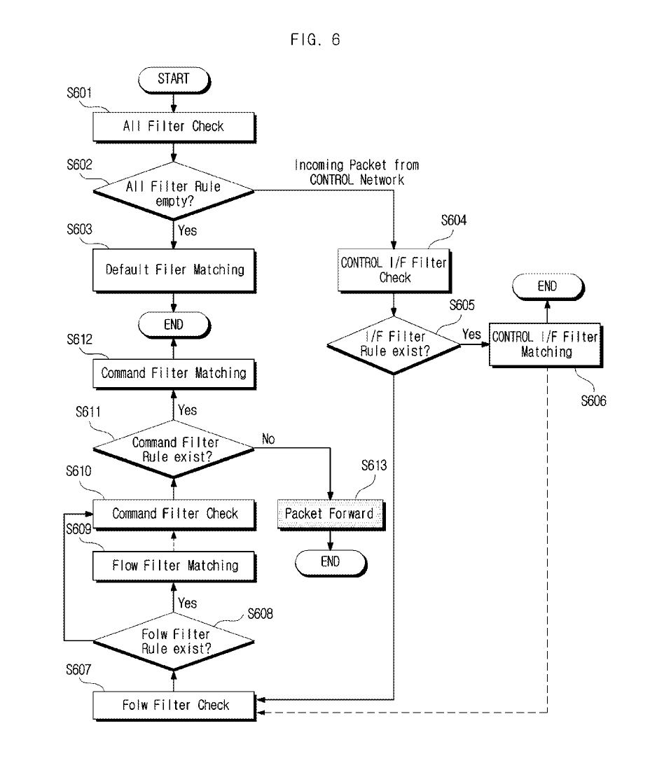

FIG. 6 presents a second flowchart of a method for preventing illegal access in accordance with an embodiment of the present invention.

As FIG. 6 shows, it is assumed that a packet flows in the control network group. An apparatus for preventing illegal access in accordance with the present invention can check all filters except a default filter when a packet flows therein from the control network group S601.

That is, the apparatus for preventing illegal access can judge whether or not all filters have rules therein with the check result S602.

Then, if the check result is there is no rule in all filters, the apparatus for preventing illegal access passes or blocks a packet in accordance with the default filter matching, that is the value set on the default filter S603.

Whereas, if the check result is at least one filter rule exists, the apparatus for preventing illegal access controls packet flow by using the corresponding filter as the packet flows in order therein.

At first, the apparatus for preventing illegal access checks the control I/F filter S604 whether or not it has a filter rule 6505. That is if there is a control I/F filter rule exists, the apparatus for preventing illegal access can perform the control I/F filter matching S606.

Whereas, according to the check result the apparatus for preventing illegal access can either perform the control I/F filter matching or not before going to flow filter check S607.

Next, the apparatus for preventing illegal access can judge whether or not a flow filter rule exists S608. That is, if a flow filter rule exists, it then can perform the flow filter matching S609.

Whereas, when no flow filter rule exists or after it performs the flow filter matching, it proceeds to command filter check S610.

Next, the apparatus for preventing illegal access can judge whether or not a command filter rule exists S611. That is if a command filter rule exists, it can perform the command filter matching S612.

Whereas, if there is no command filter rule exists, the apparatus for preventing illegal access can forward the packet judging at least one filter rule has been used S613.

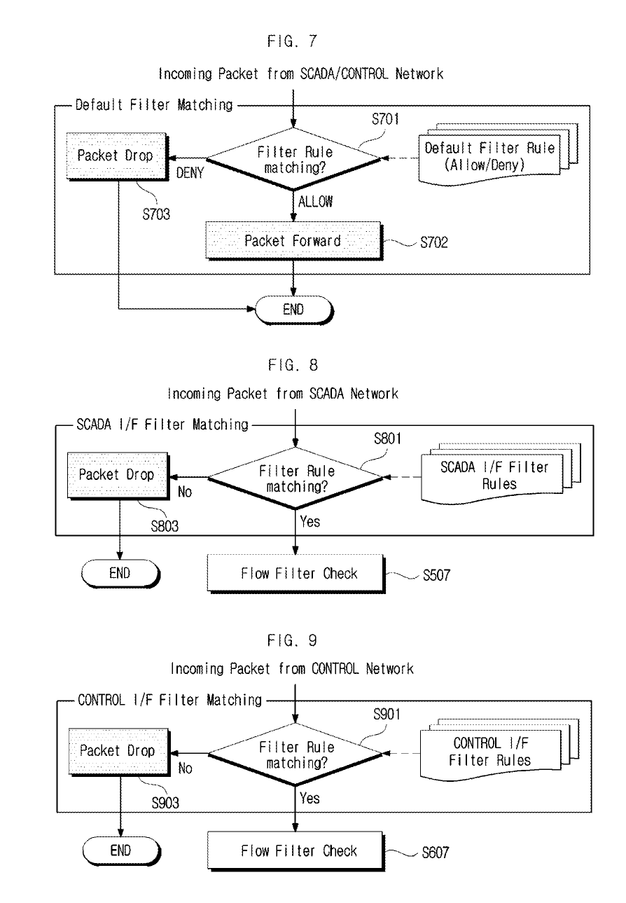

FIG. 7 presents a flowchart of a process for a default filter matching in accordance with an embodiment of the present invention.

As FIG. 7 shows, an apparatus for preventing illegal access in accordance with the present invention can check a default filter rule when a packet flows therein from the management network group or the control network group S701.

Next, if the check result for the default filter rule is set to pass a packet, the apparatus for preventing illegal access can forward the packet S702. Here, the apparatus for preventing illegal access can either pass the packet to the management network group or the control network group or controls the packet according to a SCADA I/F filter rule or a control I/F filter rule.

Whereas, if the check result for the default filter rule is set to block a packet, it judges that it is blocked by a system operator and drop the packet (S703).

FIG. 8 presents a flowchart of a process for SCADA I/F filter matching in accordance with an embodiment of the present invention.

As FIG. 8 shows, an apparatus for preventing illegal access in accordance with the present invention can check whether or not the packet flowed therein from the management network group satisfies a preset SCADA I/F filter rule S801.

Next, if it satisfies the SCADA I/F filter rule, then the apparatus for preventing illegal access can check the flow filter in FIG. 5 S507.

Whereas, if it does not satisfy the SCADA I/F filter rule, the apparatus for preventing illegal access judges that it is blocked by a system operator and drop the packet at S803.

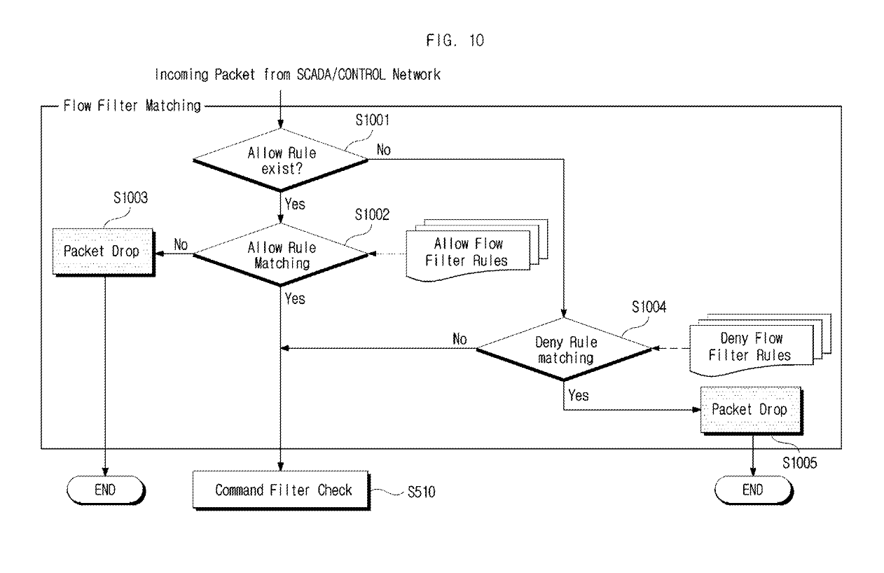

FIG. 9 presents a flowchart of a process for control I/F filter matching in accordance with an embodiment of the present invention.

As FIG. 9 shows, an apparatus for preventing illegal access in accordance with the present invention can check whether or not the packet flowed therein from the control network group satisfies a preset control I/F filter rule S901.

Next, if it satisfies the control I/F filter rule, then the apparatus for preventing illegal access can check the flow filter in FIG. 6 S607.

Whereas, if it does not satisfy the SCADA I/F filter rule, the apparatus for preventing illegal access judges that it is blocked by a system operator and drop the packet at S903.

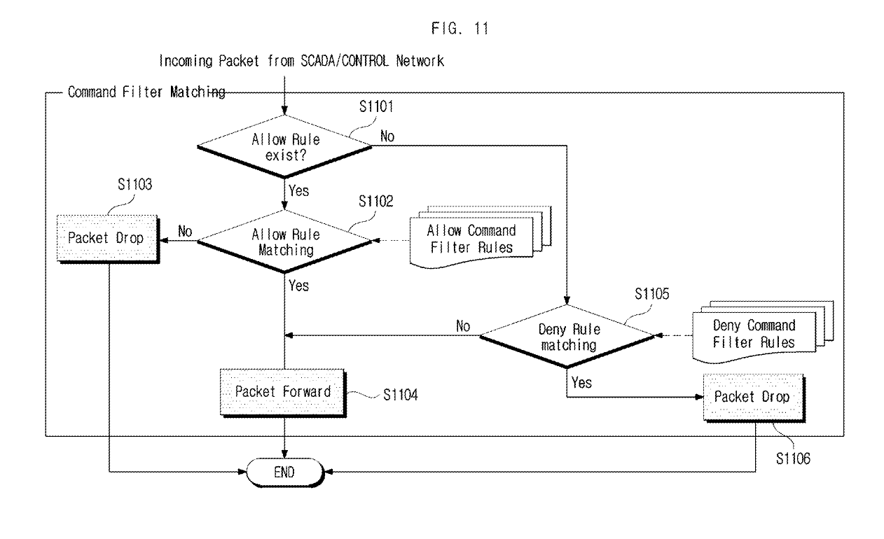

FIG. 10 presents a flowchart of a process for flow filter matching in accordance with an embodiment of the present invention.

As FIG. 10 shows, an apparatus for preventing illegal access in accordance with the present invention can check the flow filter rule for ‘allow rule’ when a packet flowed therein from the management network group or the control network group S1001.

Next, if the check result is ‘allow rule’ then the apparatus for preventing illegal access can check whether or not the packet satisfies the flow filter rule S1002. That is, if the packet satisfies the ‘allow rule’, the apparatus for preventing illegal access checks the command filter as FIG. 5 and FIG. 6 and if not satisfies, it can drop the packet at S1003.

Whereas, if the check result is not ‘allow rule’ then the apparatus for preventing illegal access can check whether or not the packet satisfies a ‘deny rule’ of the flow filter judging the result is ‘deny rule’ S1004.

That is the apparatus for preventing illegal access can drop the packet judging the set has done by an operator if the packet satisfies the flow filter's deny rule S1005, and it can check the command filter as FIG. 5 and FIG. 6 if the packet does not satisfies S510, S610.

FIG. 11 represents flowcharts explaining a process of applying a command filter rule in accordance with an embodiment of the present invention.

As FIG. 11 shows, an apparatus for preventing illegal access in accordance with the present invention can check the command filter rule for ‘allow rule’ when a packet flowed therein from the management network group or the control network group S1101.

Next, if the check result is ‘allow rule’ then the apparatus for preventing illegal access can check whether or not the packet satisfies the command filter rule S1102. That is, if the packet satisfies the ‘allow rule’, the apparatus for preventing illegal access passes the packet S1103 if not satisfies, it can drop the packet at S1104.

Whereas, if the check result is not ‘allow rule’ then the apparatus for preventing illegal access can check whether or not the packet satisfies a ‘deny rule’ of the command filter judging the result is ‘deny rule’ S1105.

That is, if the packet satisfies the command filter's deny rule, the apparatus for preventing illegal access can drop the packet at S1106 and if not satisfies it can forward the packet S1104.

Although it is described above that all elements constituting the embodiment of the present invention are combined or operated in combination, the present invention is not necessarily limited to what has been described herein.

That is, two or more of the elements constituting the embodiment of the present invention can be selectively combined with one another or operated in combination with one another as long as such combination is within the object of the present invention. Moreover, although it is possible that every element is realized as its own individual hardware, it is also possible that some or all of the elements are selectively combined with one another to be realized as a computer program having a program module that performs the combined some or all functions in one or more hardware. Moreover, the embodiment of the present invention can be realized by having said computer program stored in computer-readable media, such as USB memory, CD disk, flash memory, etc., and read and executed by a computer. The computer-readable media can also include magnetic recording media, optical recording media, carrier wave media, etc.

The embodiment of the present invention described so far is only an example so various modification and transformation are possible for people who work in the technical area of the present invention as long as not distracting the original intention of the present invention. Therefore the embodiment disclosed in the present invention is not for limiting the technical philosophy of the present invention but for explaining and the scope of the technical philosophy of the present invention are not to be limited by the embodiment. The protected scope of the present invention ought to be understood by the scope of claims below, and all technical philosophy which resides in the scope as equivalent as the scope of claims is included in the rights of the present invention.

What is claimed is:

1. An apparatus for preventing illegal access of industrial control system, comprising:
a first interface communicating a packet by interoperating with a management network group that requests a control command;
a second interface communicating a packet by interoperating with a control network group that receives a control command from the management network group and processes it; and
a control device, which, when a packet flows therein from the management network group or the control network group, checks whether or not at least one filter rule is set and controls the packet flow between the management network group and the control network group using the filter where the rule is set.

2. The apparatus for preventing illegal access of industrial control system of claim 1, wherein the control device includes a default filter which passes or blocks the packet in accordance with a preset value, and, if no filter rule is set, the control device passes or blocks the packet using the default filter.

3. The apparatus for preventing illegal access of industrial control system of claim 1, wherein the control device includes a SCADA I/F filter which performs access control of the packet from the management network group, based on a rule having a source's address, and if a SCADA I/F filter rule is set, the control device passes or blocks the packet based on SCADA I/F filter rule.

4. The apparatus for preventing illegal access of industrial control system of claim 3, wherein the control device includes a flow filter which performs access control of the packet from the management network group or the control network group, based on a rule having a protocol, a source's address, a destination address, a source's port, and a destination's port and, if no rule is set in the SCADA I/F filter or after the control device controls the packet through the SCADA I/F filter, the control device passes or blocks the packet according to whether or not the packet satisfies the flow filter rule.

5. The apparatus for preventing illegal access of industrial control system of claim 4, wherein the control device includes a command filter which performs access control of the packet from the management network group or the control network group based on a rule which includes a command and, if no rule is set in the flow filter or after the packet is controlled through the flow filter, the control device passes or blocks the packet according to whether or not the packet satisfies the command filter rule.

6. The apparatus for preventing illegal access of industrial control system of claim 1, wherein the control device includes a control I/F filter which performs access control of the packet from the control network group, based on a rule which includes a source's address, and the control device passes or blocks the packet according to whether or not the packet satisfies the control I/F filter rule set in the control I/F filter rule.

7. The apparatus for preventing illegal access of industrial control system of claim 6, wherein the control device includes a flow filter which performs access control of the packet from the management network group or the control network group based on a rule which includes a protocol, a source's address, a destination address, a source's port, and a destination's port and if no rule is set in the control I/F filter or after the control device controls the packet through the control I/F filter, the control device passes or blocks the packet according to whether or not the packet satisfies the flow filter rule.

8. The apparatus for preventing illegal access of industrial control system of claim 7, wherein the control device has a command filter which performs access control of the packet from the management network group or the control network group, based on a rule which includes a command and if no rule is set in the flow filter or after the control device controls the packet through the flow filter, the control device passes or blocks the packet according to whether or not the packet satisfies the command filter rule.

9. A method for preventing illegal access of industrial control system, comprising:
checking if a packet is received from a management network group which requests a control command or a control network group which receives and processes the control command;
checking whether or not at least one filter rule exists if the packet is received either from the management network group or the control network group; and
controlling a packet flow between the management network group and the control network group using a filter where the rule is set.

10. The method for preventing illegal access of industrial control system of claim 9, wherein the controlling comprises:
checking a default filter which controls passing or blocking of a packet according to a preset value, if there is no other filter rule set; and
controlling passing or blocking of the packet according to the preset value.

11. The controlling method for preventing illegal access of industrial control system of claim 9, wherein the controlling comprises:
checking a SCADA I/F filter which performs access control of a packet from the management network group based on a rule which includes a source's address, if the at least one filter rule is set; and
controlling passing or blocking the packet according to whether or not the packet satisfies the SCADA I/F filter rule if the check result shows the SCADA I/F filter rule is set.

12. The controlling method for preventing illegal access of industrial control system of claim 11, wherein the controlling comprises:
if no rule is set in the SCADA I/F filter or after the packet's passing or blocking is controlled by use of the SCADA I/F filter, checking a flow filter which performs access control of the packet from the management network group or the control network group based on a rule which includes a protocol, a source's address, a destination address, a source's port, and a destination's port; and
controlling passing or blocking the packet according to whether or not the packet satisfies the flow filter rule if the check result shows the flow filter rule is set.

13. The controlling method for preventing illegal access of industrial control system of claim 12, wherein the controlling comprises:
if no rule is set in the flow filter or after the packet's passing or blocking is controlled by use of the flow filter, checking a command filter which performs access control of the packet from the management network group or the control network group based on a rule which includes a command; and
controlling passing or blocking the packet according to whether or not the packet satisfies the command filter rule, if the check result shows the command filter rule is set.

14. The controlling method for preventing illegal access of industrial control system of claim 9, wherein the controlling comprises:
checking a control I/F filter which performs access control of the packet from the control network group based on a rule which includes a source's address; and
controlling passing or blocking the packet according to whether or not the packet satisfies the control filter rule if the control I/F filter rule is set.

15. The controlling method for preventing illegal access of industrial control system of claim 14, wherein the controlling comprises:
if no rule is set in the control I/F filter or after the packet's passing or blocking is controlled by use of the control IF filter, checking a flow filter which performs access control of the incoming packets from the management network group or the control network group based on a rule which includes a protocol, a source's address, a destination address, a source's port, and a destination's port; and
controlling passing or blocking the packet according to whether or not the packet satisfies the flow filter rule, if the check result shows the flow filter rule is set.

16. The controlling method for preventing illegal access of industrial control system of claim 15, wherein the controlling comprises:
if no rule exists in the flow filter therein or after the packet's passing or blocking is controlled by use of the flow filter, checking a command filter which performs access control of the packet from the management network group or the control network group based on a rule which includes a command; and
controlling passing or blocking the packet according to whether or not the packet satisfies the command filter rule, if the check result shows the command filter rule is set.
